(19) United States
(12) Patent Application Publication
(10) Pub. No.: US 2014/0025506 A1
(43) Pub. Date: Jan. 23, 2014

(54) METHODS AND SYSTEMS FOR PROVIDING ADDITIONAL ADVERTISING INFORMATION TO A USER

(71) Applicant: Eric BAX, Altadena, CA (US)

(72) Inventor: Eric BAX, Altadena, CA (US)

(73) Assignee: Yahoo! Inc., Sunnyvale, CA (US)

(21) Appl. No.: 13/555,625

(22) Filed: Jul. 23, 2012

(51) Int. Cl. G06Q 30/02

(52) U.S. Cl. 705/14.66

(57) ABSTRACT

Techniques are provided which allow users to receive additional information relating to advertisements. Login information is received from a user. An advertisement is displayed in a browser application. A user interface action indicating interaction with the user interface element may be received. The user's contact information may be retrieved based on the login information. In response to the user interface action, additional information relating to the advertisement may be transmitted to the user in accordance with the contact information.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences.

However, traditional online ads may be distracting, and may require the user to navigate away from browsing web content to obtain additional information regarding an advertised product.

Accordingly, there is a need for techniques which provide users with additional information regarding advertised products without requiring the user to navigate away from content, and while protecting the user's privacy.

### SUMMARY

Some embodiments of the invention provide systems and methods which display a user interface element overlaying an advertisement. Login information may be received from a user. The login information may include, for example a user name and a password. By providing the login information, the user may be logged into a site such as Yahoo.com. As will be apparent to one of ordinary skill in the art, the login process may store one or more cookies on the user's computer. In some embodiments, the user's account may include information provided by the user such as an email address, mailing address, phone number, authorization to access funds from an electronic payment system, such as PayPal™, Google Checkout™, etc.

An advertisement may be displayed in a browser application, wherein the advertisement comprises a user interface element. The advertisement may include textual, graphical, audio and/or video data, and may be targeted to the user based on any number or type of targeting criteria. The advertisement may include a user interface element that may be overlaid on top of the advertisement. The user interface element may be for example, a graphical button, a link, etc. In some embodiments, the user interface element may be displayed adjacent to the advertisement. Alternatively, the user interface element may be displayed such that the user interface element is partially overlaid on top of the advertisement. As will be explained in further detail below, the user interface element may be configured such that interacting with the element using a predetermined user interface action (e.g., clicking the button) may cause a predetermined action.

A user interface action indicating interaction with the user interface element may be received. The user interface action may be for example, clicking the user interface element. In some embodiments, the user interface action may be for example, a voice command. In some embodiments, the user interface action may cause the user's computer to transmit a command to one or more server computers indicating that the user has interacted with the advertisement. The user's contact information may be retrieved based on the login information. The user's contact information may be retrieved for example, from a publisher or advertising exchange.

In response to the user interface action, additional information relating to the advertisement may be transmitted to the user in accordance with the contact information. In one embodiment, the additional information may be emailed to the user's email address. The additional information may include for example, product details, store locations, ordering instructions, etc.

In some embodiments, login information may be received from a user. The login information may include, for example a user name and a password. By providing the login information, the user may be logged into a site such as Yahoo.com. An advertisement may be displayed in a browser application. A user interface element may be selected based on one or more predetermined criteria, wherein the user interface element is selected from the group consisting of a “buy now” button and a “more info” button. The predetermined criteria may include for example, whether the user's account has authorized access to an electronic payment server (e.g., PayPal™). For example, if the user has authorized access to his PayPal™ account, then the “buy now” button will be selected. Otherwise, the “more info” button will be selected. The user interface element may be displayed overlaying the advertisement. The user interface element may be completely or partially overlaid on top of the advertisement. The user interface element may be for example, a graphical button, a link, etc. In some embodiments, the user interface element may be displayed adjacent to the advertisement. As will be explained in further detail below, the user interface element may be configured such that interacting with the element using a predetermined user interface action (e.g., clicking the button) may cause a predetermined action.

A user interface action indicating interaction with the user interface element may be received. The user interface action may be for example, clicking the user interface element. In some embodiments, the user interface action may be for example, a voice command. In some embodiments, the user interface action may cause the user's computer to transmit a command to one or more server computers indicating that the user has interacted with the advertisement. A predetermined action corresponding to the user interface element may be performed. For example, if the “more info” button was displayed, then the user's contact information may be retrieved based on the login information and, additional information relating to the advertisement may be transmitted to the user in accordance with the contact information. In one embodiment, the additional information may be emailed to the user's email address. Alternatively, if the “buy now” button is displayed, a request to purchase the advertised product may be transmitted to one or more servers, wherein payment is deducted from the user's electronic payment account, such as PayPal™, Google Checkout™, etc.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating one embodiment of the invention;

FIG. 5a is a block diagram illustrating one embodiment of the invention; and

FIG. 5b is a block diagram illustrating one embodiment of the invention.

### DETAILED DESCRIPTION

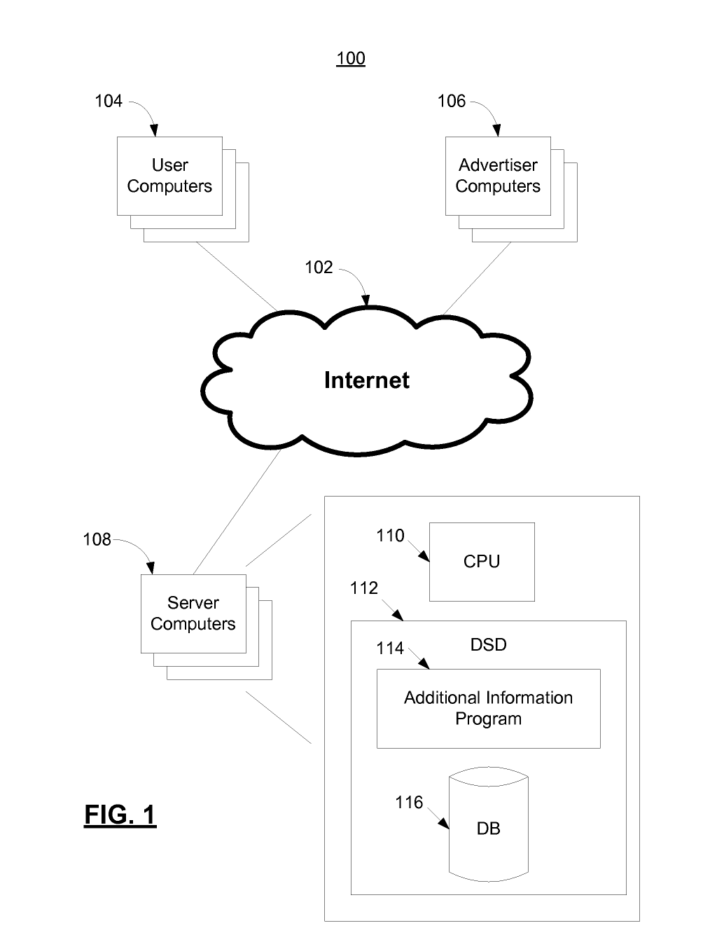

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as smart phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Additional Information Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

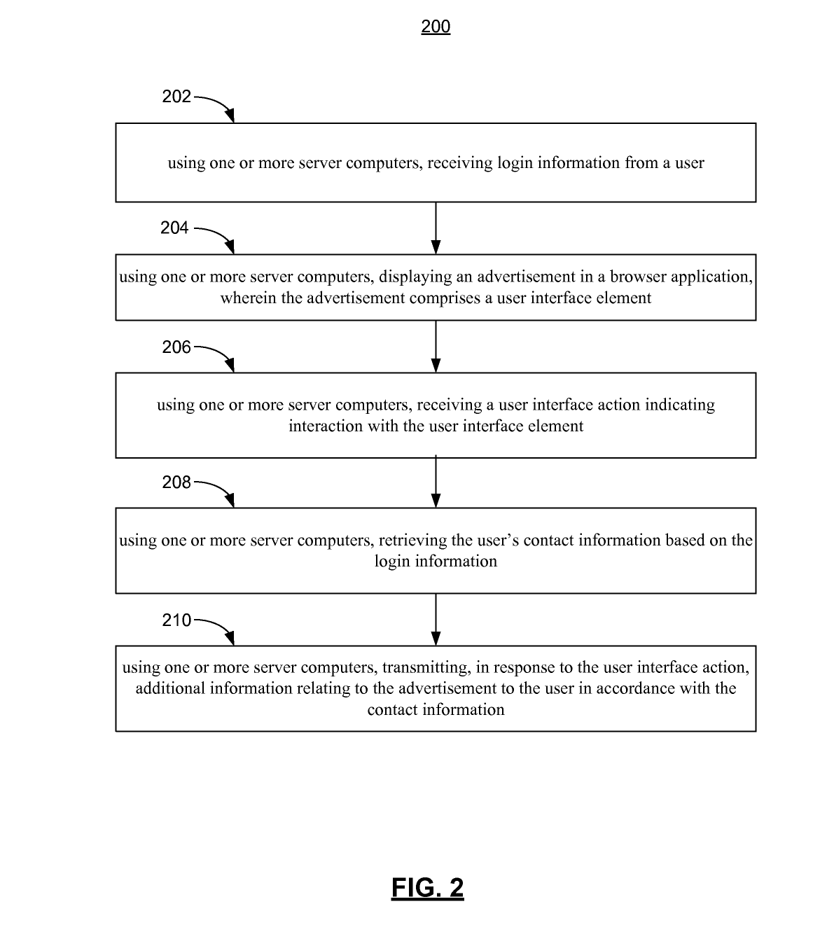

FIG. 2 is a flow diagram illustrating a method 200 according to one embodiment of the invention. At step 202, using one or more server computers, login information may be received from a user. The login information may include, for example a user name and a password. By providing the login information, the user may be logged into a site such as Yahoo.com. As will be apparent to one of ordinary skill in the art, the login process may store one or more cookies on the user's computer. Moreover, in some embodiments, the user provided login information and/or authorization to access an electronic payment system may be saved so that the user does not have to provide the login information and/or authorization on subsequent visits. In some embodiments, the user's account may include information provided by the user such as an email address, mailing address, phone number, authorization to access funds from an electronic payment system, such as PayPal™, Google Checkout™, etc.

At step 204, using one or more server computers, an advertisement may be displayed in a browser application, wherein the advertisement comprises a user interface element. The advertisement may include textual, graphical, audio and/or video data, and may be targeted to the user based on any number or type of targeting criteria. The advertisement may include a user interface element that may be overlaid on top of the advertisement. The user interface element may be for example, a graphical button, a link, etc. In some embodiments, the user interface element may be displayed adjacent to the advertisement. Alternatively, the user interface element may be displayed such that the user interface element is partially overlaid on top of the advertisement. As will be explained in further detail below, the user interface element may be configured such that interacting with the element using a predetermined user interface action (e.g., clicking the button) may cause a predetermined action.

At step 206, using one or more server computers, a user interface action indicating interaction with the user interface element may be received. The user interface action may be for example, clicking the user interface element. In some embodiments, the user interface action may be for example, a voice command. In some embodiments, the user interface action may cause the user's computer to transmit a command to one or more server computers indicating that the user has interacted with the advertisement. At step 208, using one or more server computers, the user's contact information may be retrieved based on the login information. The user's contact information may be retrieved for example, from a publisher or advertising exchange.

At step 210, using one or more server computers, in response to the user interface action, additional information relating to the advertisement may be transmitted to the user in accordance with the contact information. In one embodiment, the additional information may be emailed to the user's email address. The additional information may include for example, product details, store locations, ordering instructions, etc. The user's privacy is protected because the user's contact information is not provided to the advertiser. In addition, providing the additional information to the user via an email allows the user to continue browsing web content.

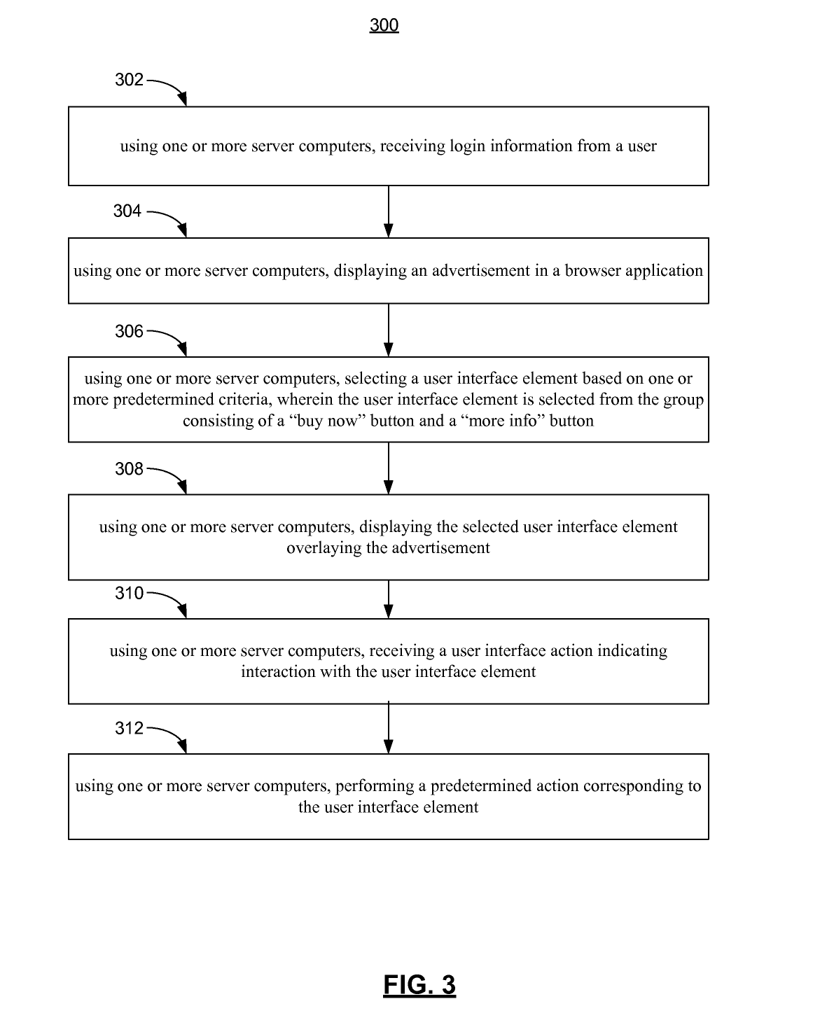

FIG. 3 is a flow diagram illustrating a method 300 according to one embodiment of the invention. At step 302, using one or more server computers, login information may be received from a user. The login information may include, for example a user name and a password. By providing the login information, the user may be logged into a site such as Yahoo.com. As will be apparent to one of ordinary skill in the art, the login process may store one or more cookies on the user's computer. Moreover, in some embodiments, the user provided login information and/or authorization to access an electronic payment system may be saved so that the user does not have to provide the login information and/or authorization on subsequent visits. In some embodiments, the user's account may include information provided by the user such as an email address, mailing address, phone number, authorization to access funds from an electronic payment system, such as PayPal™, etc.

At step 304, using one or more server computers, an advertisement may be displayed in a browser application. The advertisement may include textual, graphical, audio and/or video data, and may be targeted to the user based on any number or type of targeting criteria.

At step 306, using one or more server computers, a user interface element may be selected based on one or more predetermined criteria, wherein the user interface element is selected from the group consisting of a “buy now” button and a “more info” button. The predetermined criteria may include for example, whether the user's account has authorized access to an electronic payment server (e.g., PayPal™). For example, if the user has authorized access to his PayPal™ account, then the “buy now” button will be selected. Otherwise, the “more info” button will be selected. At step 308, using one or more server computers, the user interface element may be displayed overlaying the advertisement. The user interface element may be completely or partially overlaid on top of the advertisement. The user interface element may be for example, a graphical button, a link, etc. In some embodiments, the user interface element may be displayed adjacent to the advertisement. As will be explained in further detail below, the user interface element may be configured such that interacting with the element using a predetermined user interface action (e.g., clicking the button) may cause a predetermined action.

At step 310, using one or more server computers, a user interface action indicating interaction with the user interface element may be received. The user interface action may be for example, clicking the user interface element. In some embodiments, the user interface action may be for example, a voice command. In some embodiments, the user interface action may cause the user's computer to transmit a command to one or more server computers indicating that the user has interacted with the advertisement. At step 312, a predetermined action corresponding to the user interface element may be performed. For example, if the “more info” button was displayed, then the user's contact information may be retrieved based on the login information and, additional information relating to the advertisement may be transmitted to the user in accordance with the contact information. In one embodiment, the additional information may be emailed to the user's email address. Alternatively, if the “buy now” button is displayed, a request to purchase the advertised product may be transmitted to one or more servers, wherein payment is deducted from the user's electronic payment account, such as PayPal™

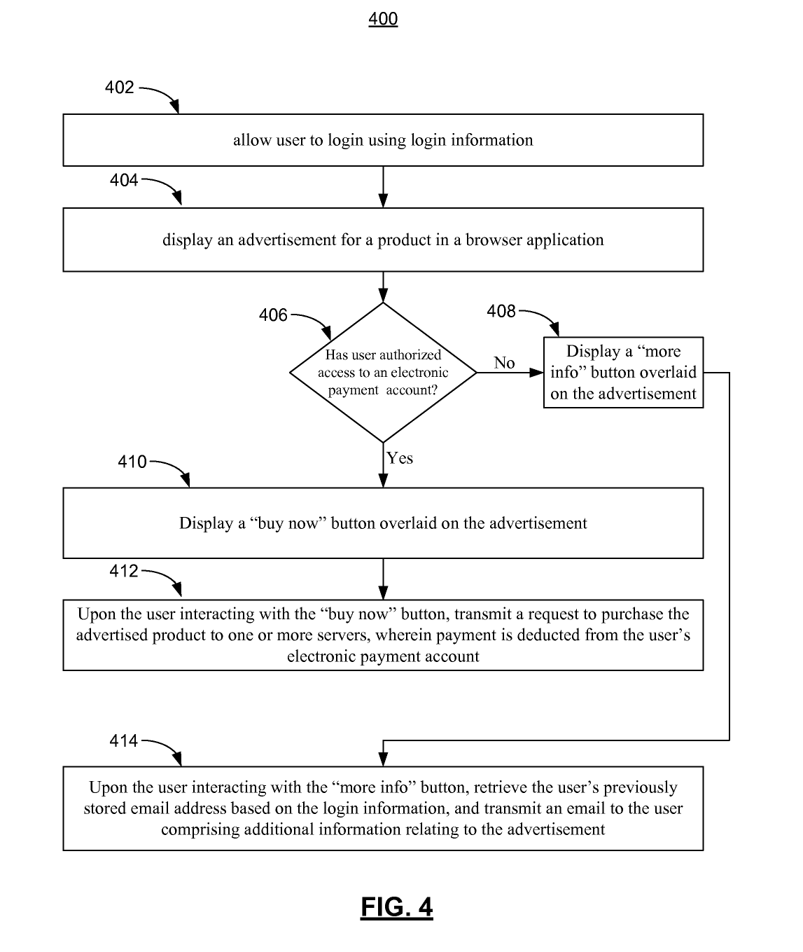

FIG. 4 flow diagram illustrating a method 400 according to one embodiment of the invention. At step 402, login information may be received from a user. The login information may include, for example a user name and a password. By providing the login information, the user may be logged into a site such as Yahoo.com. As will be apparent to one of ordinary skill in the art, the login process may store one or more cookies on the user's computer. Moreover, in some embodiments, the user provided login information and/or authorization to access an electronic payment system may be saved so that the user does not have to provide the login information and/or authorization on subsequent visits. In some embodiments, the user's account may include information provided by the user such as an email address, mailing address, phone number, authorization to access funds from an electronic payment system, such as PayPal™, etc.

At step 404, using one or more server computers, an advertisement may be displayed in a browser application. The advertisement may include textual, graphical, audio and/or video data, and may be targeted to the user based on any number or type of targeting criteria.

At step 406, it is determined if the user has authorized access to an electronic payment account, such as PayPal™. This may be determined by accessing, for example the user's Yahoo account and determining if the user previously gave permission to access his electronic payment account. If the user has not authorized access to his electronic payment account, or if the user does not have an electronic payment account, a “more info” button is displayed overlaying the advertisement in step 408. Alternatively, if the user has authorized access to his electronic payment account, a “buy now” button is displayed overlaying the advertisement in step 410. In step 414, the user may interact with the “more info” button by for example, clicking the “more info” button. In some embodiments, the user may interact with the “more info” button using for example, a voice command. Upon the user interacting with the “more info” button, the user's contact information may be retrieved based on the login information. The user's contact information may be retrieved for example, from a publisher or advertising exchange. Additional information relating to the advertisement may be transmitted to the user in accordance with the contact information. In one embodiment, the additional information may be emailed to the user's email address. The additional information may include for example, product details, store locations, ordering instructions, etc.

In step 412, the user may interact with the “buy now” button by for example, clicking the “buy now” button or using a voice command. Upon the user interacting with the “buy now” button a request to purchase the advertised product may be transmitted to one or more servers, wherein payment is deducted from the user's electronic payment account. The purchased product may be shipped to the user's previously provided mailing address.

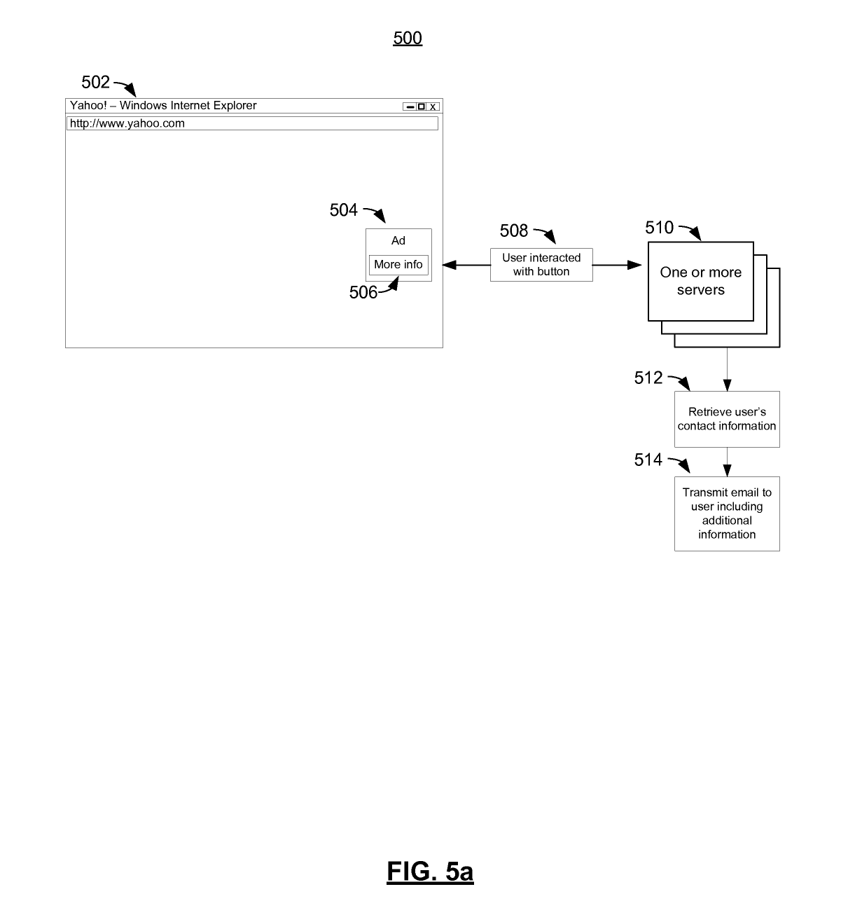

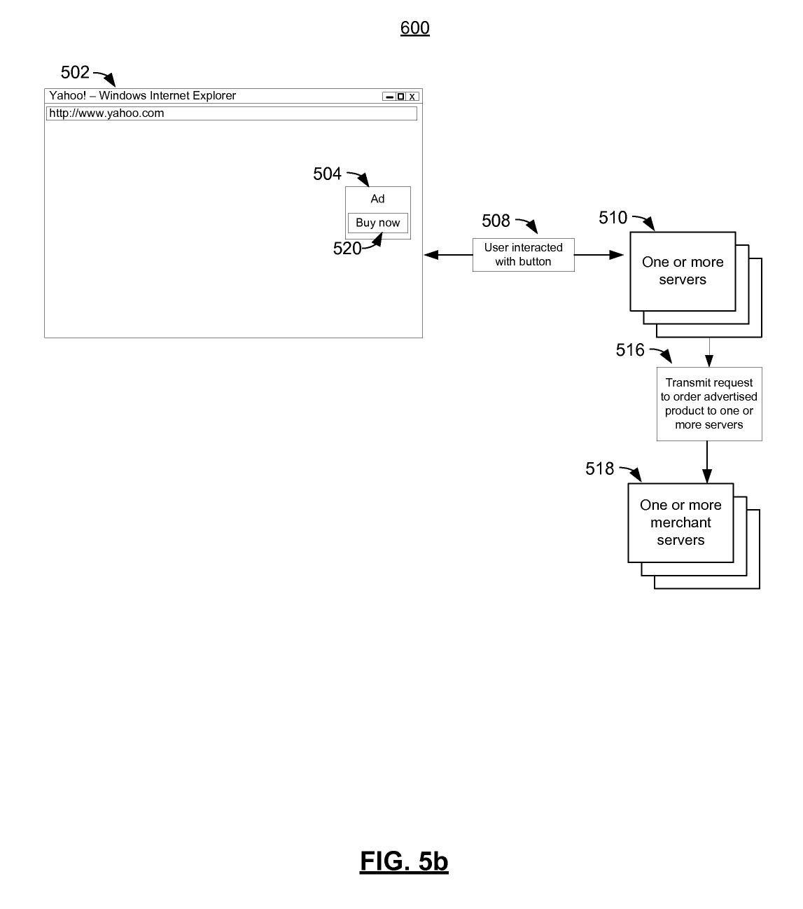

FIG. 5a is a block diagram 500 illustrating one embodiment of the invention. A screenshot 502 of a browser application window in accordance with one embodiment of the invention is depicted. An advertisement 504 is displayed in the browser window. Overlaid on top of the advertisement is “More info” button 506. In some embodiments, button 506 may be overlaid partially on top of advertisement 504, or may be displayed adjacent to advertisement 504. Upon the user interacting with button 506, by for example clicking or using a voice command, a command is transmitted, as shown in block 508, to one or more servers 510 indicating that the user has interacted with button 506. One or more servers 510 may retrieve the user's contact information, such as an email address, as shown in block 512. It should be noted that, in this embodiment, it is assumed that the user has previously logged in. If the user is not logged in, upon the user interacting with button 506, the user will be asked to login. In block 514, an email may be transmitted to the user's email address including additional information relating to advertisement 504. The additional information may include, for example product details, store locations, ordering instructions, etc.

FIG. 5b is a block diagram 600 illustrating one embodiment of the invention. A screenshot 502 of a browser application window in accordance with one embodiment of the invention is depicted. An advertisement 504 is displayed in the browser window. Overlaid on top of the advertisement is “Buy now” button 520. In some embodiments, button 520 may be overlaid partially on top of advertisement 504, or may be displayed adjacent to advertisement 504. Upon the user interacting with button 520, by, for example clicking or using a voice command, a command is transmitted, as shown in block 508, to one or more servers 510 indicating that the user has interacted with button 520. One or more servers 510 may transmit a request to purchase the advertised product to one or more merchant servers 518. Merchant server 518 may deduct payment from the user's electronic payment account. It should be noted that, in this embodiment, it is assumed that the user has previously logged in and provided authorization to access his electronic payment account. If the user is not logged in or has not provided authorization to access his electronic payment account, upon the user interacting with button 520, the user will be asked to login or provide authorization to access his electronic payment account. Moreover, in some embodiments, the user provided login information and/or authorization to access an electronic payment system may be saved so that the user does not have to provide the login information and/or authorization on subsequent visits.

While the invention is described with reference to the above drawings, the drawings are intended to be illustrative, and the invention contemplates other embodiments within the spirit of the invention.

1. A method comprising:
using one or more server computers, receiving login information from a user;
using one or more server computers, displaying an advertisement in a browser application, wherein the advertisement comprises a user interface element;
using one or more server computers, receiving a user interface action indicating interaction with the user interface element;
using one or more server computers, retrieving the user's contact information based on the login information; and
using one or more server computers, transmitting, in response to the user interface action, additional information relating to the advertisement to the user in accordance with the contact information.

2. The method of claim 1, wherein the user interface element is a graphical button.

3. The method of claim 1, wherein the user interface element is displayed overlaying the advertisement.

4. The method of claim 1, wherein the user interface element is displayed adjacent to the advertisement.

5. The method of claim 1, wherein the user interface action comprises clicking the user interface element.

6. The method of claim 1, wherein the contact information comprises at least an email address.

7. The method of claim 6, wherein transmitting the additional information comprises transmitting an email comprising the additional information to the email address.

8. The method of claim 1, wherein the additional information comprises one or more of product details, store locations, review information, and purchase instructions.

9. The method of claim 1, further comprising:
using one or more server computers, receiving the additional information from an advertiser.

10. A system comprising:
one or more server computers coupled to a network; and
one or more databases coupled to the one or more server computers;
wherein the one or more server computers are for:
receiving login information from a user;
displaying an advertisement in a browser application, wherein the advertisement comprises a user interface element;
receiving a user interface action indicating interaction with the user interface element;
retrieving the user's contact information from the one or more databases based on the login information; and
transmitting, in response to the user interface action, additional information relating to the advertisement to the user in accordance with the contact information.

11. The system of claim 10, wherein the user interface element is a graphical button.

12. The system of claim 10, wherein the user interface element is displayed overlaying the advertisement.

13. The system of claim 10, wherein the user interface element is displayed adjacent to the advertisement.

14. The system of claim 10, wherein the user interface action comprises clicking the user interface element.

15. The system of claim 10, wherein the contact information comprises at least an email address.

16. The system of claim 15, wherein transmitting the additional information comprises transmitting an email comprising the additional information to the email address.

17. The system of claim 10, wherein the additional information comprises one or more of product details, store locations, review information, and purchase instructions.

18. The system of claim 10, wherein the one or more server computers are further configured for:
receiving the additional information from an advertiser.

19. The system of claim 10, wherein the user interface element is a link.

20. A non-transitory computer readable storage medium having stored thereon instructions for causing a computer to execute a method, the method comprising:
receiving login information from a user;
displaying an advertisement in a browser application;
selecting a user interface element based on one or more predetermined criteria, wherein the user interface element is selected from the group consisting of a “buy now” button and a “more info” button;
displaying the selected user interface element overlaying the advertisement;
receiving a user interface action indicating interaction with the user interface element;
performing a predetermined action corresponding to the user interface element.
